(19) United States
(12) Patent Application Publication
(10) Pub. No.: US 2006/0262462 A1
(43) Pub. Date: Nov. 23, 2006

(54) Concealed Safety Lighting and Alerting System

(75) Inventor: Robert A. Barton, Grafton, MA (US)

Correspondence Address: ROBERT A. BARTON, 56 BARBARA JEAN STREET, GRAFTON, MA, 01519, US

(73) Assignee: Robert A. Barton, Grafton, MA (US)

(21) Appl. No.: 11/457,867

(22) Filed: Jul. 17, 2006

Related U.S. Application Data
(63) Continuation-in-part of application No. 10/710,189, filed on Jun. 24, 2004, now Pat. No. 7,118,235.
Application No. 10/710,189 is a continuation-in-part of application No. 10/249,723, filed on May 3, 2003, now Pat. No. 6,805,469.

(51) Int. Cl. H02H 3/00

(52) U.S. Cl. 361/1

(57) ABSTRACT

A concealed safety lighting and alerting system is described where a power failure light, night light, visual and audio alarm are integrated into an electric wiring device and its cover plate. An electric wiring device with built-in safety condition sensing is described. A cover plate with features for emitting light is also described. The electric wiring device contains a sensing circuit that provides a signal to control a system safety device that may be a safety lighting source, audible alarm source or both. The cover plate may contain a variety of components allowing the system designer to expand the functionality of the system while keeping design complexity low. The system is modularly designed to overcome space limitations found when combining the multiple safety functions and controls into an electric wiring device that fits into conventional electric work boxes.

### CROSS REFERENCE TO RELATED APPLICATIONS

This application is a continuation-in-part of application Ser. No. 10/710,189 filed on Jun. 24, 2004 which is a continuation-in-part of application Ser. No. 10/249,723 filed on May 3, 2003, now U.S. Pat. No. 6,805,469.

### BACKGROUND OF INVENTION

Emergency lighting devices and other system safety devices are typically installed in such obvious ways that they interfere with visible design and decor of a living space or workspace. Alerting lights or audible alarms for safety conditions frequently require specific installation and wiring. This often affects a person's decision on whether or not to install them. The present invention describes a safety lighting and alerting device that is fairly inconspicuous by integrating it with commonly used electrical wiring devices such as switches, dimmers, and receptacles. This will likely have the result of more installations and thus safer homes and workplaces.

The present invention relates generally to power failure safety lighting devices and, more specifically, to a modular safety lighting system that combines power failure and other safety condition sensing functionality, with standard electrical wiring devices such as, but not limited to, switches, dimmers, lighting controls and receptacles. The resulting electrical wiring device can detect safety conditions and provide a safety signal when power failures and other predetermined safety conditions are present. The safety signal is used to turn on a system safety device which is a safety light and/or audible alarm source. The safety signal is electrically connected to an interface on the electrical wiring device that communicates directly or indirectly with the system safety device. This provides the ability to place the system safety device in direct contact with or external to the electrical wiring device as compared with related prior art inventions.

The present invention is a modular system having a safety condition sensing circuit within an electrical wiring device to sense a variety of safety conditions such as power failure and others described herein. The present invention has other modular functions such as but not limited to the safety lighting source located in the cover plate. This modular system offers improvements over prior art where space is limited when designing and placing the safety lighting source, audible alarm source, light sensor, or user interface control within the electrical wiring device itself. Newer designs of conventional passive cover plates are emerging as larger structures that may be integral to the electrical wring device mounting mechanism. These larger cover plate sizes offer a stylized appearance and compliment the room decor and appeal to many users upon installation. The present invention allows one or more modular components of the safety lighting device to reside in the cover plate, resulting in reducing overall design complexities and offering other improvements to the manufacturing process over the related concealed safety lighting device of prior art invention.

### DESCRIPTION

In U.S. Pat. No. 6,805,469, the safety lighting source and all user interface control is integrated into the electrical wiring device. The '469 patent describes a concealed safety light that relies on using a conventional cover trim plate to finish off the installation. This reliance allows a user to simply replace a normal switch or receptacle with the concealed safety light and still use the same conventional cover plate.

Electric wiring devices are well known and recently are becoming more sophisticated, having more features and controls available to the user on the exposed face, thus making even the most complex devices recognized and accepted as standard electrical wiring devices. The present invention takes advantage of the existence of these newer, more sophisticated electrical wiring device styles to advance the practice of concealing a safety light in plain view because people are getting used to a variety of styles and functionality where switches and receptacles are normally installed. The present invention does this by being similar in design to many electrical wiring devices while presenting functional safety alerting elements that may be noticeable to the observant user while remaining unobtrusive.

The present invention uses the cover plate as an element of the system for concealing a safety light in plain view. Manufacturing an integrated switch and safety system presents complex real estate issues when placing all of the desired features in the visible portions of the electrical wiring device. The present invention mates a cover plate with an electric wiring device that contains a safety condition sensing circuit and an interface to communicate a signal. The electrical wiring device includes but is not limited to one or more of the following: a switch, dimmer, lighting control, receptacle, or a similarly shaped housing, that comprises the sensing circuit that is connected to primary power. The sensing circuit comprises power failure or other alarm condition sensing and generates a signal which is electrically connected to a first interface. The first interface may be wired, wireless or use optical coupling such as IR transmit/receive. The sensing circuit may also include an ambient light sensing or darkness signal function.

The cover plate of the present invention comprises one or more of the following components: a user interface for controlling the device, a safety light source, audible alarm source, a light transmission means, a light sensor, an alternate power source, and an interface to allow communication between the modular components in the cover plate and the integrated sensing circuit of the electrical wiring device. The light transmission means may be a lens, hole, void, reflector or light pipe.

A signal that is derived from a primary power source is used for power failure detection. The power failure sensing function is equally functional in AC or DC primary power systems by making changes to the primary power interface circuitry. This affords power failure protection to standard AC electrical systems as found in most homes, offices and inhabited spaces, as well as automobiles, trailers, boats, mechanical and telecommunication equipment rooms and includes many of today's alternate energy systems that rely on DC battery power.

### DESCRIPTION OF PRIOR ART

Similar prior art safety lighting devices that light up when a power failure occurs, are often embodied in the form of a housing that is used as a wall cover plate that surrounds an existing switch or receptacle electrical wiring device. Their embodiments are designed to mechanically and electrically attach to an already in-place standard switch or receptacle either by direct attached wiring, plug tangs, or wireless means. Prior art devices do not disclose a system that relies upon the electrical wiring device to sense when power has failed or to monitor for other safety condition alert signals. This requires having a sensing circuit integrated into the electrical wiring device which no unrelated prior art describes. This new integrated arrangement gives conventional electrical wiring devices the capability of sensing certain safety conditions like power failure or other alarm triggering events where audible alarm alerts or a visible light provides warning and safe passage to those nearby. The modular nature of the concealed safety lighting and alerting system relies on this integrated sensing capability within the electrical wiring device to enable using the cover plate to achieve improved alerting solutions. This includes having the cover plate contain alternate power source batteries or having multiple light sources and larger light emitting areas for the safety light to illuminate the surrounding area or a lighting source and an audible alarm source.

There are electrical wiring devices on the market that contain an audible alert function that emits an alerting noise to specific conditions relating to the function of the electric wiring device. One such product is a surge suppression receptacle model 7280 by Leviton that will emit sound when the protection is off. This audible alarm is not able to respond to externally generated alert signals.

Other than the '469 patent, prior art does not perceive or address the problem of being conspicuous, thus limiting the locations where one would install safety lighting and alerting devices. The system of the present invention includes an electrical wiring device that is substantially the same size and shape and may also perform the function of the common wall switch, dimmer or receptacle. It installs into the standard electrical workboxes and provides the function of the safety system. It is unobtrusive upon the installation of a cover plate which contains one or more elements of the system, thus overcoming the problem of being conspicuous.

In U.S. Pat. No. 3,739,226 Seiter describes an emergency light for mounting to an electrical wall socket. The apparatus for emergency lighting plugs into a receptacle. It is easily visible and conspicuous in its display and mounting mechanism.

In U.S. Pat. No. 4,514,789 Jester describes an illuminated light switch plate with LED and oscillator circuit to replace a cover plate. It is intended to locate the wall switch in the dark. It is a cover plate that does not teach power failure detection or backup lighting mechanism.

In U.S. Pat. Nos. 5,473,517, 5,713,655, and 6,010,228 Blackman describes a housing with an emergency safety lighting apparatus that replaces the cover plate and mechanically attaches to the wall switch device using the same screw mounting holes previously used by a standard cover plate. The entire safety light solution is contained in the cover plate and is not integrated with the electrical wiring device that it covers. The electrical wiring device is any standard switch or receptacle that has no sensing circuit. The housing containing the safety light is much larger than a standard cover plate leaving it somewhat obtrusive and noticeable when installed. A wireless interface is described that does not communicate with a sensing circuit in the electrical wiring device, but merely senses the electromagnetic waves generated by the proximal primary AC power.

In U.S. Pat. Nos. 5,833,350 and 6,000,807 Moreland describes a switch cover plate that houses the apparatus for emergency lighting. It is similar to Blackman in that it is much larger than a standard cover plate and is self contained. It is not an electrical wiring device, but merely an active cover plate.

In U.S. Pat. No. 4,631,649 McCue describes a plug-in emergency light fixture that plugs into a wall receptacle and is semi-permanently mounted by screwing it to the receptacle. None of the components are part of the receptacle and it is not concealed or inconspicuous when installed.

In U.S. Pat. Nos. 6,051,787, 5,811,729, 5,811,730 and 5,874,693, Rintz describes an electroluminescent switch cover plate having an electroluminescent panel electrically connected to the primary power being switched. It does not teach a power failure lighting device or a distributed system of components to achieve such function. It is not integrated with the wiring device but merely attaches to the primary power directly. In U.S. Pat. No. 7,009,111, Rinz further describes a flexible cover for switches that does have power failure lighting function using the same concept of replacing the cover plate. It utilizes standard switches and receptacles having no integrated sensing circuitry.

In U.S. Pat. Nos. 6,423,900 and 6,087,588, Soules describes an active cover plate for a variety of purposes having rearward facing contacts for connecting with primary power. It relies on a conventional receptacle or switch. It does not describe or teach a power failure lighting device, nor a system having components or circuitry integrated with the receptacle.

Prior art generally discloses backup power failure lighting devices that either plug into a power receptacle or replace the cover plate that surrounds conventional switches and receptacles. Prior art does not describe a safety condition signal sensing circuit integrated into electrical wiring devices. The present invention distributes modular elements of the safety lighting and alerting system into subsystems that are integrated with a) an electrical wiring device that fits into the electrical workbox and b) the cover plate that covers the installed electrical wiring device and optionally c) a remote central system module. The cover plate may be integrated with the electrical wiring device housing or mounting bracket having snap retainers or tabs or other mounting mechanisms to allow one to remove a portion of it for installation purposes then reassemble for final appearance. The cover plate has a surface area that provides for easier placement of one or more system safety devices, user interface mechanisms, batteries and/or light sensor devices and other modules as described herein. The present invention occupies the same physical space and may provide the function of a conventional switch, dimmer, lighting control or receptacle, while simultaneously providing safety functions such as illumination to an area when darkness falls, with or without primary power being available. It also provides an audible alert noise when certain predetermined safety conditions exist, thus rendering the present invention a concealed safety lighting and alerting device.

The object of the present invention is to conceal the safety light and alerting system as much as possible by taking advantage of the ubiquitous nature and visible acceptance of electrical wiring devices. The present invention fits within the electrical workbox and is covered with a cover plate that may contain one or more active components. This allows the safety lighting device to be installed in many locations wherever electric wiring devices are found today. The device is installed in the same places as a conventional switch, dimmer or receptacle and covered with the cover plate. The resulting device provides nighttime safety lighting and other various alarm alerting whether primary power is available or not with minimal visible impact on the design or décor of the area where the device is installed.

### SUMMARY OF INVENTION

The present invention is an electric wiring device that has internal Sensing circuit that monitors for multiple safety conditions: power failure; various alarm input event signals; darkness using ambient light sensor signal; and a signal from a user pushbutton or switch. The sensing circuit generates a safety signal—either electrical, optical or wireless, PLC, IP or Bluetooth, etc. when one of the conditions occur. The safety signal is used either directly or indirectly to energize a system safety device which is a safety lighting source or audible alarm source. The system safety device may be directly connected to the safety signal using any suitable connection method and produce light and/or sound by drawing power directly from the safety signal. When the internal circuit detects darkness it can raise the safety signal whether there is primary power or not, thus providing a night lighting or power failure safety lighting function by using an alternate power source.

The concealed safety lighting and alerting system optionally provides an audible signal and/or intermittent flashing of light to differentiate types of safety alerts during predetermined alarm conditions. Concealment of the safety system is accomplished by enabling an electric wiring device having a sensing circuit that sends a signal to a first interface when an unsafe condition exists. The unsafe condition may be power failure or the receipt of an external signal generated by other safety monitoring systems such as intrusion, fire, water or gas alarms. The Concealed Safety Lighting and Alerting System responds with visible lighting or audible signals or both. The cover plate is mounted over the electric wiring device and contains one or more functional modules as decided by the system designer.

The Concealed Safety Lighting and Alerting System of the present invention is designed to fit in the same places that switches, receptacles, dimmers and other such wiring devices are designed to fit. The primary power interface provides a source to monitor and subsequently derive the signal to adjust power to a safety lighting source and/or audible alarm source which is in communication with said first interface to illuminate the room area through the cover plate for the electrical wiring devices. The Concealed Safety Lighting and Alerting System may be arranged in a variety of ways by placing functional modules in the electrical wiring device and in the cover plate using a wired, optical or wireless interface within the scope of this present invention.

In one of the Concealed Safety Lighting and Alerting System's simplest forms, a safety lighting source or audible alarm source mates directly with the first interface of the electrical wiring device either permanently or removably. The cover plate contains at least one of: a guide, void, reflector or lens to allow the light from a safety lighting source to illuminate the area or to transmit an audible sound external to the cover plate.

In another simple embodiment, the electrical wiring device sensing circuit drives a small IR or visible light LED, or electromagnetic transmission device as the first interface that sends signals toward the cover plate. The cover plate contains a receiver as a second interface that keeps the system safety device off until loss of signal from the first interface. This has the advantage of electrically isolating the cover plate from the electric wiring device and to reduce alignment issues when installing the cover plate.

In a more robust embodiment, a second interface that communicates with said first interface is affixed to the cover plate such that a communication path exists between the cover plate and the sensing circuitry that is integrated into the electrical wiring device. When the safety lighting source is affixed to the cover plate and in communication with the second interface, the first and second interfaces are in communication while installed and complete the communication path between the safety lighting source or audible alarm source, in the cover and the signal provided by the sensing circuit in the electrical wiring device.

In other embodiments, the first and second interfaces also provide a pathway for signal communication between the power sensing or other alarm signal circuit integrated in the electrical wiring device and any one or more of the following: the safety light source an audible alarm source, a user interface, an alternate power source and/or a light sensor. The first and second interfaces may be wireless or direct contact. When designed with a direct contact, one or more of the first and second interface contact lines may be used as a power source supplying power to one or more functions. When a wireless interface is employed, the safety lighting source or audible alarm source is enabled and disabled by the presence or lack thereof of a signal or other circuit contact closure and relies on an alternate power source to power the wireless interface for the system safety device.

The Concealed Safety Lighting and Alerting System of the present invention comprises an electrical wiring device installed in its usual manner within a conventional electrical workbox. The electrical wiring device may be controlling an electrical load and therefore may include exemplary devices such as a switch, electric light dimmer, and receptacle including arc sensing or GFCI receptacles. A receptacle may not have anything plugged in and therefore may not be controlling an electric load or the wiring device may be a housing that does not control any load except the load of the electrical wiring device itself. The system's electrical wiring device portion includes a sensing circuit that is connected to a primary power source for detecting the presence or lack of presence of the primary power. An alternate power source and a safety lighting source are connected to the sensing circuit in such a way as to deliver alternate power to the safety lighting source when primary power fails. The alternate power signal may be switched using an electromechanical contact closure such as in a relay or reed switch, or it may be driven using solid state devices, selection being made on cost and space and other issues. An optional light sensing mechanism determines when light should be turned on whether there is primary power available or not. A user control mechanism such as but not limited to a switch, slider or pushbutton may be used to turn on and off the systems alerting device or adjust brightness levels of the safety light and can be a multifunction control or simple on-off or test switch.

The housing is specifically shaped in the form of any conventional electrical wiring device such that it fits in the same places. It may be a switch, dimmer, power receptacle, or a housing body having substantially the same shape as these conventional electrical wiring devices having at least the Sensing circuit and first interface. This housing shape with said primary electrical wiring interface allows the installation of the safety lighting and alerting system in the same places as switches, dimmers and power receptacles. It may contain a local alternate power source or remote power source depending on the specific model and safety alerting coverage required. Constructing the safety lighting and alerting system with a module having the same form factor as conventional electrical wiring devices, regardless of whether they function as the original electric wiring device or not, provides the concealment objective and the unobtrusive appearance characteristics of the present invention.

The term conceal in the context of the present invention does not mean hidden completely from view. The use of the term conceal describes an unobtrusive looking device, substantially similar in shape, size and function of a conventional electrical wiring device such that its presence is easily accepted and unobtrusive as if it were hidden in plain view.

The alternate power to the safety light device may be provided by rechargeable batteries or other electrical power storage devices or a non-rechargeable power source by implementing a simple change to the DC low power circuitry. The battery may be integrated with the electrical wiring device, the cover plate, or remotely located using class 2 or class 3 low voltage wiring. When contained in the cover plate, the alternate power source is safely handled upon removing the cover plate thereby disengaging all contact from said first electrical connector of the electrical wiring device. A battery status indicator may be implemented to alert the user when batteries need replacement or maintenance. An optional light sensor adjusts the intensity of the safety light according to available lighting conditions such as daylight, thereby extending the battery life.

The present invention may deliver illumination using the available primary power and thus provide a nightlight function using the safety lighting source. The nightlight safety lighting may also be controlled by the optional ambient light sensor in the same way as the power failure safety light. This arrangement, along with using a low power safety light source, for example an LED, provides low cost energy saving illumination and little or no heat when compared with standard incandescent nightlights.

Multiple concealed safety light system devices may be installed and controlled by electrically communicating with a remote system module having a detection and signaling mechanism to provide safety lighting economically. The safety lighting system may protect multiple areas by having a single detection mechanism or a single alternate power source electrically coupled to the light sources concealed in several safety lighting system devices. The safety lighting system devices may be a single, fully functional safety lighting system device and cover plate or a cost reduced system having a centralized system module coupled to a basic safety light system device and cover plate having few local controls and no local battery. The cost of the concealed safety lighting and alerting system may be reduced when several of the electric wiring devices and cover plates are installed in a living space providing broad coverage in a dwelling and having a remote sensor circuit gather input signals and communicate a signal to the electrical wiring device upon detection of a safety event. The electrical wiring device's sensing circuit may communicate with a remote central system module through low power DC wiring, wireless, IP protocols, or using coded signals such as X10, UPB or other Power Line Communication (PLC), or Power Line Bus (PLB) communication protocols over the primary power wiring. This remote central system module may have an interface to allow fire, smoke, gas, intrusion or any other alarm signals to enable the concealed safety lighting and alerting system to audibly and/or visually alert the occupants or security personnel of an alarm condition. This allows persons in the affected area, including those with hearing impairment, to be alerted.

The modular versatility of the present invention offers the system designer a variety of ways to overcome space limitations and other design complexity issues by distributing portions of the circuit functions between the electrical wiring device and the cover plate of the present invention. A system designer may choose to implement all of the sensing circuit including the safety lighting source and/or the audible alarm source completely in the electrical wiring device, requiring a light or audio transmission means in the associated cover plate.

It is well known that cover plates are available in a variety of shapes and sizes and may even be integral to the electrical wiring device's mounting mechanism. The present invention takes advantage of this variety to camouflage the installation thus concealing in plain view the entire safety lighting and alerting system. Electrical wiring devices with cover plates are found in many locations and are in plain view, serving the purposes for which they are designed thus providing an unremarkable and concealed appearance for a safety lighting and alerting device. While mainly applicable to utility supplied AC power to inhabited places, the present invention may be implemented into wiring devices for enclosed spaces where it is necessary to have some light for safety reasons such as automobiles, planes, boats, trains and trucks. The primary power may be Direct Current (DC) and the cover plates in these spaces may be convenience light switch panels, map light switch panels, tilt switch enabled light enclosures or other specially designed housings and control panels in which electrical wiring devices are installed.

In summary, the Concealed Safety Lighting and Alerting System of the present invention provides its users increased safety and security by providing illumination in the form of night lighting, power failure lighting, and alarm condition audio or visual warning indication and is concealed in an electrical wiring device in such a way that is acceptable to install without detracting from local surrounding area design and décor.

A primary object of the present invention is to provide a system of components that when installed, form a safety lighting and alerting signaling solution that utilizes the space normally occupied by an electrical wiring device and its cover plate to improve safety.

Another object of the present invention is to enable common electric wiring devices to monitor and detect predetermined safety events and to supply a signal to indicate that said events occurred.

Another object of the present invention is to enable electric wiring device cover plates to be the source of a safety alerting signal without detracting from its original purpose, function and general design, thus helping to conceal or camouflage the safety lighting and alerting features.

An additional object of the present invention is to improve the manufacturability and features of the concealed safety lighting device of U.S. Pat. No. 6,805,469 by utilizing the space and area afforded by the cover plate to improve placement options for the present safety lighting and alerting system's components. This is accomplished by moving one or more functions into the cover plate thereby reducing the size requirements, shape and form of the electrical wiring device and reducing the complexity of placing the optional user interface components such that the user may conveniently access the features of the present invention.

A further object of the present invention is to provide a safety lighting system that is similar to and appears to be a commonly installed electrical wiring device thus having little or no visible impact on interior space designs, effectively concealing it in plain view, and thus overcoming the shortcomings of prior art devices.

Another object of the present invention is to provide an alert using one or more system safety devices that provide light or audible noise for the purpose of making users aware of the existing safety condition.

A further object of the present invention is to provide audible and/or visual warning to alert users that an alarm condition exists from smoke, fire, gas, water, intrusion, or other alarm events and systems thereby improving safety and security in many places.

Another object of the present invention is to provide a system for providing safety lighting and alerting that is able to detect the occurrence of a power failure.

Another object of the present invention is to provide a system for providing safety lighting and alerting in an inconspicuous manner to multiple room areas during power failures and other safety conditions by installing it in many locations throughout a house, building, vehicle or other space equipped with primary power.

A further object of the present invention is to provide a concealed safety lighting device that includes a light detection mechanism for reducing the intensity of the emergency light when other light sources such as daylight are available to extend the life of the alternate power source during extended power outages or determining when nightlight operation should begin, or whether audio or visual alerting should be used.

A still further object of the present invention is to provide a concealed safety lighting and alerting device that includes a user control for selectively turning the safety light off during a power outage to conserve battery life if lighting is not desired or needed in that area for a specific period of time.

Another object of the present invention is to provide a concealed safety lighting and alerting device with a safety lighting source that can be adjusted to different levels of brightness by signal command or at the user's discretion.

Another object of the present invention is to provide a concealed safety lighting and alerting device that is activated and available for use with no specific action to be taken by the user.

A still further objective of the present invention is to provide safety lighting in the darkness regardless of the state and availability of primary power.

Another object of the present invention is to provide nighttime lighting when primary power is available for use as a nightlight in a concealed, unobtrusive manner allowing for a more child safe, non-removable night lighting device to take the place of the plug-in lighting devices found today.

A still further object of the present invention is to provide a concealed safety lighting and alerting device that is economical in cost to manufacture resulting in end user costs that imply affordability allowing for immediate commercial use.

An additional object of the present invention is to be easy to install with no additional knowledge necessary than that needed to install or replace conventional receptacles or switch devices.

Numerous devices for providing alternate safety lighting have been provided in the prior art. While these units may be suitable for the particular purpose to which they address, they would not be as suitable for the purposes of the present invention as heretofore described.

Additional objects of the present invention will appear as the description proceeds. A concealed safety lighting and alerting system is disclosed by the present invention. The concealed safety lighting and alerting system includes an electrical wiring device form factor, a cover plate, a first interface, a local or remote power source, a local or remote safety condition sensing circuit connected to the primary power source for detecting a voltage failure of said primary power source, an alternate power source, one or more safety light sources connected between the detection circuit and the alternate power source and a means to transmit the light from the light source into the room area, an optional audible alarm source to audibly alert users to an existing safety condition.

To the accomplishment of the above and related objects, this invention may be embodied in the forms illustrated in the accompanying drawings or other forms described in the present application, attention being called to the fact, however, that the drawings are illustrative only, and that changes may be made in the specific construction illustrated and described, within the scope of the appended claims.

### BRIEF DESCRIPTION OF DRAWINGS

Various other objects, features and attendant advantages of the present invention will become more fully appreciated as the same becomes better understood when considered in conjunction with the accompanying drawings, in which like reference characters designate the same or similar parts throughout the several views and exemplary embodiments. Many variations of the shape and function of the concealed safety lighting and alerting system are possible. For the purpose of demonstrating the versatility of the present invention, the figures and drawings depict several different examples of the variations. Other designs are possible within the scope of the present invention.

FIG. 1A shows the main components of one embodiment of the concealed safety lighting and alerting system, specifically the cover plate, and the electrical wiring device in the form of a switch having a first interface. FIG. 1B is a rear view of the cover plate and its possible components that form the concealed safety lighting and alerting system.

FIG. 2A shows a second embodiment of the main components of the concealed safety lighting and alerting system, specifically the cover plate and the electrical wiring device in the form of a classic receptacle having a first interface. FIG. 2B is a rear view of the cover plate and its modular components that form the concealed safety lighting and alerting system.

FIG. 3A is a front view of a third embodiment showing a decorative style switch and oversized cover plate having a lens for the safety light transmission and a user interface control. FIG. 3B is a rear view of the same cover plate showing a light transmission means, second interface and safety lighting source and circuit board. FIG. 3C is an exploded view of the system components in the form of a decorative style electrical wiring device and its associated cover plate.

FIGS. 4A and 4B show the safety lighting system components in the form of a decorative receptacle. FIG. 4C shows a simple embodiment having at least a light guide in the cover plate through which the safety lighting source can emit light into a room area.

FIGS. 5A, through 5G are reference design schematic diagrams of circuits for the concealed safety lighting and alerting system of the present invention. Each figure demonstrates various functional components of the system and how they may be distributed between the electrical wiring device and the cover plate. Various other combinations are possible within the scope of the present invention.

FIG. 6 is a functional block diagram of the Concealed Safety Lighting and Alerting System of the present invention.

FIG. 7 shows one example of a remote central system module having multiple concealed safety lighting and alerting system devices. The devices communicate with the remote central system module via power line communication signals and have an optional low voltage wiring interface for powering system safety devices. System safety devices may be a safety lighting source used to provide steady or intermittent light and/or an audible alarm source to alert users of the safety condition. Power failures require safety lighting in the form of steady illumination, while other safety condition alarms require either light or noise to warn users of the safety condition.

### DESCRIPTION OF THE REFERENCED NUMERALS

Turning now descriptively to the drawings, in which similar reference characters denote similar elements throughout the several views, the figures illustrate the concealed safety lighting device in different embodiments of the present invention. With regard to the reference numerals used, the following numbering is used throughout the various drawing figures.
10. Safety lighting source.
12. System safety device.
15. Audible alarm source.
20. Switch device housing.
25. Receptacle device housing.
30. Light transmission means.
35. Audio transmission means.
40. Ambient light sensor.
45. Clear or translucent area.
50. User interface control.
55. Sensing circuit.
60. Alternate power source.
70. First interface.
80. Second interface.
90. Circuit board.
100. Switch Cover Plate.
110. Receptacle Cover Plate.
120. Primary power interface
130. Circuit board retainer
140. Switch mounting bracket.
145. Receptacle mounting bracket.
146. Mounting holes.
147. Screw.
150. Electrical utility work box.
160. Lens.
165. Rear cover.
170. Snap retainer.
180. Electric wiring device.
400. Low battery warning indicator.
410. Powerline communications interface.
420. Signal decode logic.
430. Voltage supply bus.
440. First diode.
450. Wireless transmitter module.
460. Wireless receiver module.
480. Wireless antenna.
490. Optical wireless emitter.
495. Optical wireless receiver.
700. Remote central system module.
710. Power Line Control signal.
720. Low voltage wiring.
740. Remote light sensor.
750. Primary power supply cord.
760. Remote sensing circuit.
770. Remote battery.
775. Remote test button.
780. Alarm input event interface connector.
790. Safety lighting and alerting device.

### DETAILED DESCRIPTION

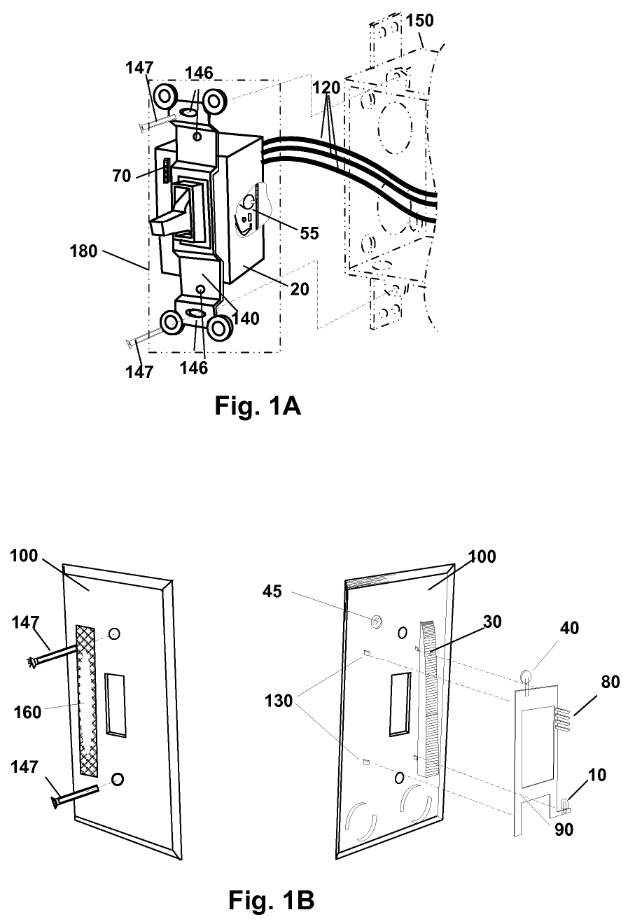

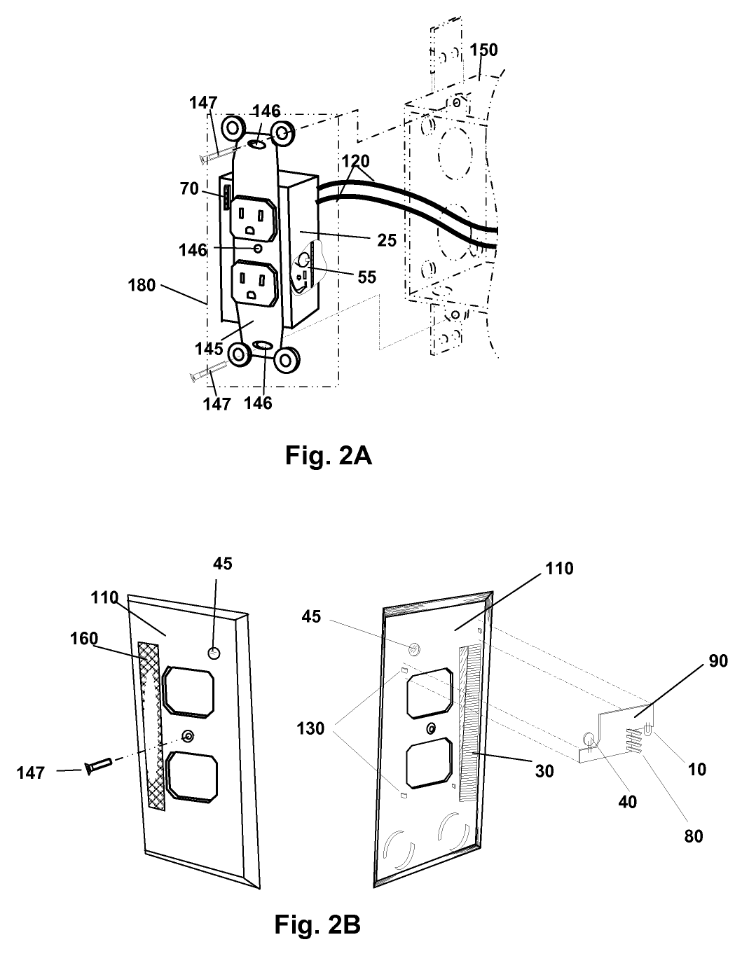

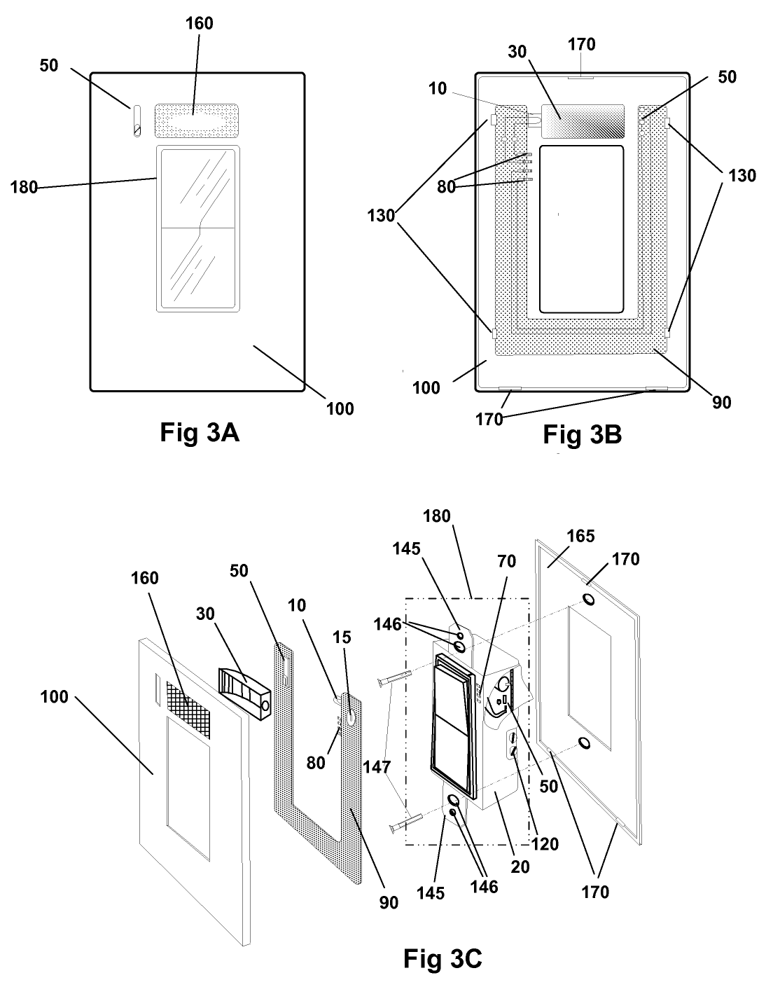

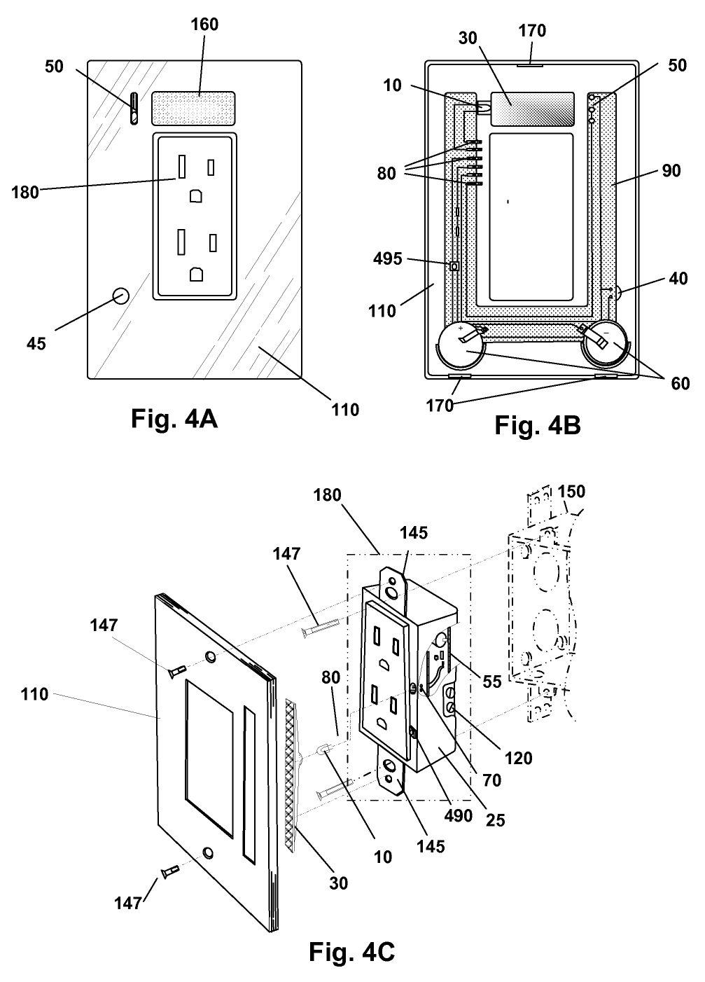

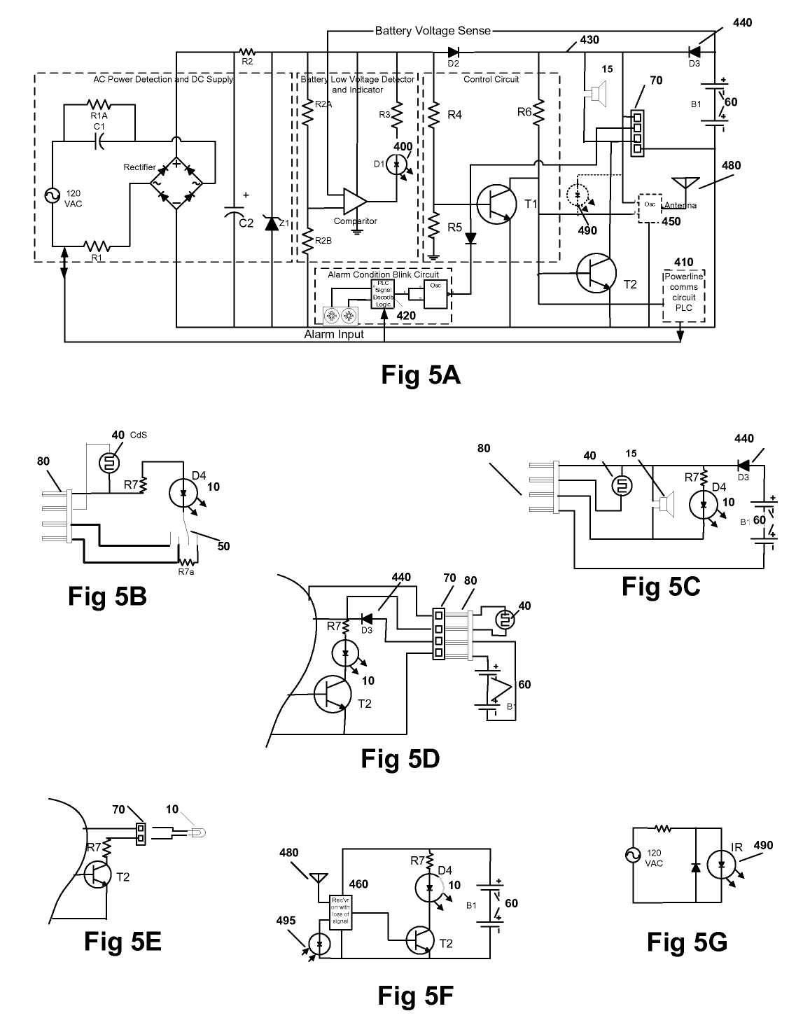

Turning now descriptively to the drawings, in which similar reference characters denote similar elements throughout the several views, FIGS. 1A through 4C illustrate examples of different embodiments of the concealed safety lighting and alerting system of the present invention. FIGS. 1A through 2C illustrate classic styles of switches and receptacles and cover plates. Other implementations for the concealed safety lighting device using decorative or Decora wiring devices are shown in FIGS. 3A through 4C depicting how substantially similar their structure and function are in allowing any style wiring device to be used to conceal a safety lighting and alerting system of the present invention. FIGS. 5A thru 5G show examples of circuit designs that can be used to implement the system, particular attention being paid to FIGS. 5B through 5F which demonstrate how various functions of the system can be mounted separate from the electrical wiring device. FIG. 5G shows a simple sensing circuit for the electric wiring device.

FIGS. 1A and 1B show one embodiment of a concealed safety lighting and alerting system. FIG. 1B shows a switch cover plate 100 having a lens 160 as viewed from the front of the switch cover plate 100. The safety lighting source 10 is mounted on circuit board 90 in such a way as to allow the light to diffuse through light transmission means 30 such as a reflector or light pipe which allows light to exit through lens 160 in the front of switch cover plate 100. Ambient light sensor 40 is mounted on circuit board 90 in such a way as to sense ambient light levels through clear or translucent area 45 causing adjustment of the level of power to the safety lighting source 10. Circuit board 90 is mounted to the rear facing side of switch cover plate 100 utilizing circuit board retainers 130. FIG. 1A shows the electric wiring device 180. Switch device housing 20 is attached to switch mounting bracket 140 having all the standard structure to allow installation into a conventional electrical utility work box 150 and cover with a cover plate using mounting holes 146. Switch device housing 20 contains the sensing circuit 55 in communication with a first interface 70 to electrically communicate with the second interface 80 on circuit board 90. The system otherwise appears substantially the same as a conventional switch device when switch cover plate 100 is attached, thereby covering the entire device installation. The primary voltage interface 120, electrically connects the concealed safety lighting and alerting system to the primary power source.

FIGS. 2A and 2B show another embodiment of a concealed safety lighting and alerting system. FIG. 2A shows the electric wiring device 180 that is a receptacle device housing 25 that mounts into an electrical utility work box 150 using screws 147 through mounting holes 146. The receptacle device housing 25 contains the sensing circuit 55 in communication with first interface 70 and a primary voltage interface 120. FIG. 2B shows a receptacle cover plate 110, having a lens 160 as viewed from the front of the receptacle cover plate 110. FIG. 2B also shows the rear facing side of the receptacle cover plate 110. Circuit board 90 is mounted to the receptacle cover plate 110 using circuit board retainer 130. Safety lighting source 10 emits light into light transmission means 30 where it is conveyed to the front of receptacle cover plate 110 and through lens 160. The second interface 80 mates with first interface 70 when receptacle cover plate 110 is mounted to the electrical wiring device 180.

FIG. 3A shows a front view of yet another embodiment of the concealed safety lighting and alerting system having a decorator style switch. The electric wiring device 180 is covered by switch cover plate 100 having lens 160 and a user interface control 50.

FIG. 3B shows the rear of switch cover plate 100 having circuit board 90 mounted using several of circuit board retainer 130. The user interface control 50 is mounted through circuit board 90. Safety lighting source 10 is mounted in such a way that the light emitted is directed through light transmission means 30 which guides the light through switch cover plate 100 through lens 160. Snap retainer 170 is use to affix switch cover plate 100 to an optional rear cover 165.

FIG. 3C shows an exploded view of the concealed safety lighting and alerting system having a decorator style switch. In this example, safety lighting source 10 is mounted on circuit board 90 and uses light transmission means 30 to convey the light through lens 160. The electric wiring device 180 is mounted to an electric utility work box using screws 147 through mounting holes 146 and captures a rear cover plate 165. Primary voltage enters the device through primary voltage interface 120 which are screws that are electrically connected to primary power when installed. Switch cover plate 100 is mounted over the electric wiring device 180 causing first interface 70 to mate with second interface 80 completing the concealed safety lighting and alerting system circuitry. The switch cover plate 100 is held in place by engaging snap retainers 170 on rear cover 165. When safety lighting source 10 is energized, the light exits the front of the assembly through lens 160.

FIG. 4A shows a front view of another embodiment of the concealed safety lighting and alerting system having a decorator style receptacle. The electric wiring device 180 is covered by receptacle cover plate 110 having lens 160 and a user interface control 50. An optional clear or translucent area 45 to allow ambient light to pass through the receptacle cover plate 110 is shown.

FIG. 4B shows the rear of receptacle cover plate 110 having circuit board 90 mounted using several of circuit board retainer 130. The user interface control 50 is mounted through circuit board 90. Safety lighting source 10 is mounted in such a way that the light emitted is directed through light transmission means 30 which guides the light through receptacle cover plate 110 through lens 160. Ambient light sensor 40 is mounted on circuit board 90 which receives light through the clear or translucent area 45. Snap retainer 170 is use to attach receptacle cover plate 110 in place.

FIG. 4C shows an exploded view of a similar concealed safety lighting and alerting system having a decorator style receptacle. In this example, safety lighting source 10 is mounted directly to first interface 70 and uses light transmission means 30 in receptacle cover plate 110 to convey the light through the receptacle cover plate 110. The electric wiring device 180 is mounted to an electric utility work box 150 using screws 147 through mounting holes 146 in receptacle mounting bracket 145. Primary voltage enters the device through primary voltage interface 120 which are screws that are electrically connected to primary power when installed. Sensing circuit 55 monitors the primary voltage and generates a signal on the first interface 70 when a power failure or other safety alert condition is present. Receptacle cover plate 110 is mounted over the electric wiring device 180 and held in place by retaining screws 147. When safety lighting source 10 is energized, the light exits the front of the assembly through light transmission means 30. When audible alarm source 15 is installed on circuit board 90, an audible alert is generated when energized. At the system designers discretion, optical wireless emitter 490 and optical wireless receiver 495 may be used as an alternative interface.

Sensing circuit Operation Description. The following describes one design of how the safety condition sensing reference design circuitry operates to provide necessary function as described in the present invention.

Referring to FIG. 5A, the Primary Power Detection and DC Supply circuit represents a common transformer-less low power DC power supply design and may be implemented locally or remotely in other power supply designs without impacting the scope of this present invention.

Battery Low Voltage Detector: Many devices are currently available to detect a voltage threshold and activate an indicator. This is one design to demonstrate how the present invention is able to incorporate the function. This circuit is optional and may be omitted without impacting the scope of the present invention.

FIGS. 5A through 5G demonstrate examples of how the components of the safety lighting and alerting system may be distributed between the electrical wiring device and its associated cover plate in various combinations without impacting the scope of the present invention. FIGS. 5A and 5C demonstrate how the audible alarm source 15 may be implemented and have several components mounted in the cover plate. FIG. 5B shows ambient light sensor 40, alternate lighting source 10, and user interface control 50 located in the cover plate connected to second interface 80. FIG. 5C shows ambient light sensor 40, audible alarm source 15, alternate lighting source 10, first diode 440, and alternate power source 60 connected to second interface 80 affixed to the cover plate. FIG. 5D shows the alternate power source 60 and ambient light sensor 40 located in the cover plate connected to second interface 80. FIG. 5E shows safety lighting source 10 connected directly to first interface 70 allowing a system designer to implement a simple embodiment as previously described. FIG. 5F shows a wireless receiver module 460 having a wireless antenna 480 or optical wireless receiver 495, capable of turning on a safety lighting source 40 upon loss of wireless signal. FIG. 5G shows a very simple power sensing circuit driving a signal using an optical wireless emitter 490.

Control Circuit: In this example power-signal circuit, transistor T1 is held in the on state through resistor divider network R4 and R5 as long as primary power is available. The output of T1 will keep the audible alarm source 15 or safety lighting source 10 in the off state by turning off transistor T2. The output of T1 may also be used to enable a wireless transmitter module 450 or optical wireless emitter 490. Current flow while primary power is applied is supplied through D2 through R6, through T1. In this reference example, ambient light sensor 40 may have no function when primary power is on since R4 will hold T1 on, T2 off and audible alarm source 15 or safety lighting source 10 off. The ambient light sensor 40 may function when primary power is on by eliminating or reducing the value of R4.

When primary power is unavailable, transistor T1 will control the brightness of the safety lighting source 10 through the ambient light sensor 40 which will develop a lower resistance as more light is detected. This raises the bias voltage on the base of transistor T1 with respect to the amount of ambient light detected, thereby turning off audible alarm source 15 or safety lighting source 10 and reducing current drain on the alternate power source battery 60 to extend its useable life. Transistor T1 will also respond to a detected alarm condition signal and turn T2 on with a predetermined steady or flashing signal resulting in light or audible noise being emitted regardless of the state of the ambient light sensor 40.

When primary power is available, transistor T1 can optionally be used to control the brightness of the safety lighting source 10, through the ambient light sensor 40 and to provide a night light function by changing the value of the bias voltage at the base of T1 to a value that allows transistor T1 to turn off when a predetermined light level is reached. In this case, audible alarm source 15 is not installed.

Power Failure Operation: The power failure detection circuit is based on having a primary power source, an alternate power source 60 and at least one diodal element passing current in only one direction. The primary power source normally provides power to a common voltage supply bus 430. This bus is electrically connected to a diodal element, in this reference example, first diode 440, passing current in one direction. First diode 440 is electrically connected to the alternate power source with an associated polarity that will allow the alternate power source 60 to supply power to the voltage supply bus 430. First diode 440 is reversed biased while primary power is available to the voltage supply bus causing no electrical discharge of the alternate power supply. When primary power is no longer available, the first diode 440 becomes forward biased causing the alternate power source to discharge to the load that is electrically connected to the voltage supply bus 430. A second diodal element may be electrically connected to the voltage supply bus 430 in opposite polarity to the first diode 440 as a means of preventing current flow to portions of the circuitry when supplied by alternate power source 60. This circuit arrangement allows for automatic failover of supplying power to the voltage supply bus 430. The load that is electrically connected to the voltage supply bus 430 continues to be powered when primary power has failed. The load comprises elements used to derive a power failure signal that is supplied to various other features of the circuit.

Control Circuit: The safety lighting source 10, in this reference example a light emitting diode, will remain off while transistor T2 is off. Resistor R7 limits the amount of current through the LEDs and is chosen to optimize light output and battery life. The optional on-off-test switch 50 will allow the audible alarm source 15 or safety lighting source 10 to be activated. The low voltage detector circuit is designed into the circuit in such a way as to trigger the low battery warning indicator 400 when primary power is present and the battery voltage falls below a certain voltage determined by the resistor divider R2A and R2B.

Alarm Condition Blink Circuit: Receiving a coded signal or closing the circuit at the Alarm Input terminals causes the signal decode logic 420 to enable the oscillator circuit to intermittently pull down the base of T1 regardless of the state of the ambient light sensor 40 or the state of primary power. This signal allows transistor T2 to turn current on and off through the audible alarm source 15 or safety lighting source 10 causing said safety lighting source 10 to blink or audible alarm source 15 to beep in response to the alarm condition. When activated, the Powerline communications interface 410 sends a coded signal out over the primary power lines through primary power supply that can be received by any concealed safety lighting and alerting device equipped with optional alarm condition blink circuitry containing signal decode logic 420.

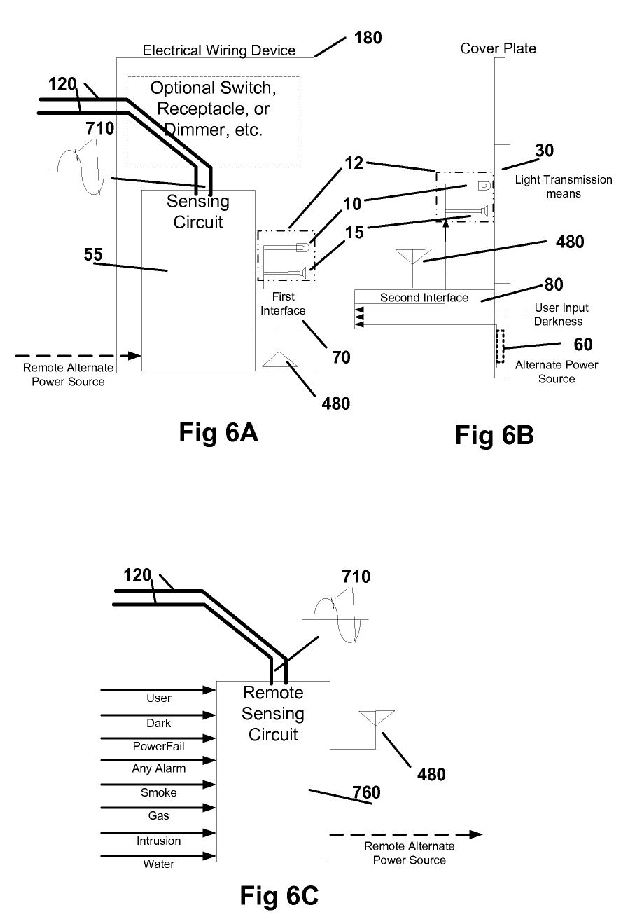

FIG. 6A through FIG. 6C shows a functional block diagram of the Concealed Safety Lighting and Alerting System. FIG. 6A shows the electrical wiring device 180 having a primary power interface 120, a sensing circuit 55, a first interface 70. A power line control signal 710 is shown as an input to sensing circuit 55. The System safety device 12 is shown as either a safety lighting source 10 or audible alarm source 15 or both. FIG. 6B shows a cover plate having at least a light transmission means 30, a second interface 80, and additional modules of the system including user input and darkness sensing inputs to the sensing circuit 55 of the electrical wiring device 180 of FIG. 6A. FIG. 6C shows the modularity of the system by having a remote sensing circuit 760 with multiple alarm inputs providing a signal using power line control signal 710 over primary power interface 120 and optionally supplying alternate power to the electrical wiring device 180 in FIG. 6A.

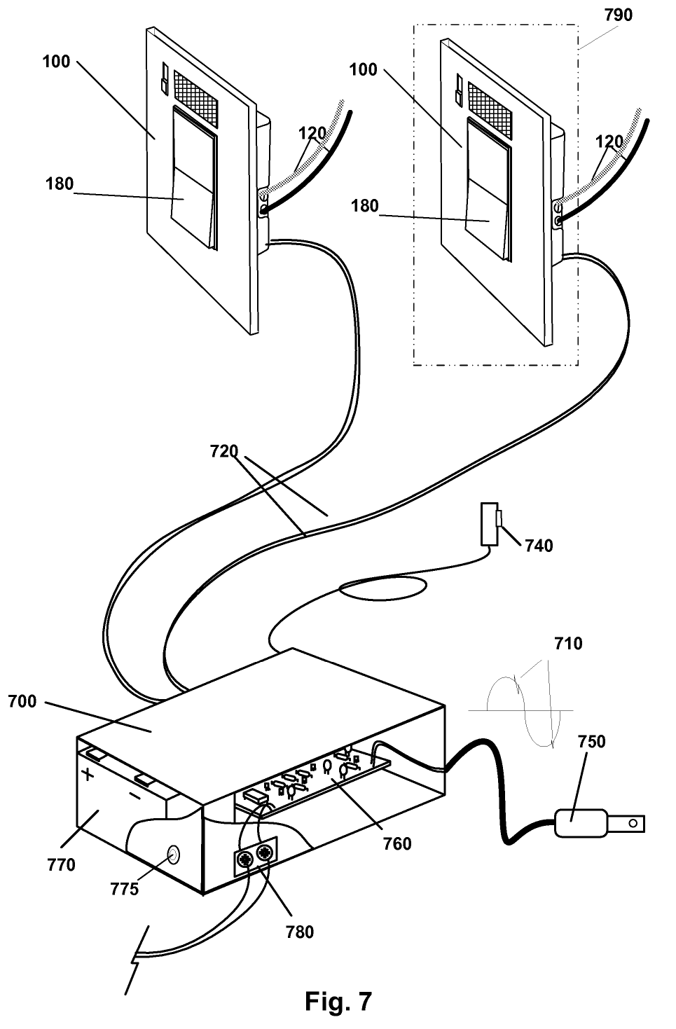

FIG. 7 shows the concealed safety lighting and alerting system implemented with a remote central system module 700. The remote central system module 700 is connected to primary power through Primary power supply cord 750. Remote light sensor 740 monitors available light while alarm input event interface connector 780 monitors external safety detection systems for alerting conditions. Power Line Control signals 710 are sent over the primary power wiring to the individual concealed safety lighting and alerting device 790 via their primary power interface 120 through primary power supply cord 750. Low voltage wiring 720 may be employed to deliver alternate power during power failures from the remote battery 770 to the individual concealed safety lighting and alerting devices 790. User control of the system is accomplished by pressing remote test button 775. The concealed safety lighting and alerting device is made up of electric wiring device 180 covered by switch cover plate 100.

From the above description it can be seen that the concealed safety lighting and alerting system provides safety improvements in several ways including general night lighting, power failure lighting, and an alarm condition visual and audible indication. The safety alert audio and lighting control and sensing circuit can be completely integrated into the electrical wiring device. The functions may be distributed as separate modules in electrical communication with each other. The safety lighting and alerting system concealed in electrical wiring devices may be controlled from a remote central system module.

A concealed safety lighting and alerting system that provides safety lighting and alerting in a concealed or inconspicuous way is described. It is capable of providing night lighting and alarm condition alerts using light and/or sound, and is able to detect the occurrence of a power failure and provide backup safety lighting. The backup safety lighting mechanism includes an alternate power source which can take the form of, but is not limited to non-rechargeable batteries or rechargeable batteries with sufficient power density to provide a useful lighting period during power failures. The backup safety light mechanism also includes an ambient light sensor for extending the life of the battery and turning off the nightlight feature during the day, and an optional on-off user control switch for selectively turning the safety light off when not needed. Furthermore, the concealed safety lighting and alerting system of the present invention is simple and easy to install and use, and is economical to manufacture.

While certain novel features of this invention have been shown and described using exemplary preferred embodiments, the scope of the invention is not intended to be limited to the details above, since it will be understood that various omissions, modifications, substitutions and changes in the forms and details of the device illustrated and in its operation can be made by those skilled in the art without departing in any way from the spirit of the present invention. Therefore, the scope of the claims should be accorded the broadest interpretation so as to encompass all such modifications and similar arrangements.

1. An electric wiring device comprising:
a. A housing having suitable shape and size to fit into a conventional electrical workbox, said housing having a mounting member to affix said housing to said conventional electrical workbox;
b. A primary power interface within said housing;
c. A sensing circuit to detect a predetermined condition, said sensing circuit providing a signal upon detection of said predetermined condition;
d. A first interface providing a communication path for said signal, said first interface used to communicate with a system safety device.

2. The electric wiring device of claim 1 comprising suitable structure to affix a cover plate.

3. The sensing circuit to detect a condition of claim 1, wherein said predetermined condition is one or more of the following: primary power failure, darkness, alarm input event, and manual input.

4. The sensing circuit of claim 1 comprising a user interface to control the state of said sensing circuit.

5. The sensing circuit of claim 1 comprising a power line communications interface for receiving and transmitting signals.

6. The electric wiring device of claim 1 comprising a first interface, said first interface is one of: wired, wireless, optical, and mating contacts.

7. The electrical wiring device of claim 1 comprising one or more of the following: switch, receptacle, and dimmer.

8. The system safety device of claim 1 selected from the group comprised of safety lighting source and audible alarm source.

9. The system safety device of claim 1 comprising a second interface in communication with said first interface.

10. A system for providing safety lighting and alerting comprising:
a. An electric wiring device comprising:
i. A housing having suitable shape and size to fit into a conventional electrical workbox, said housing having a mounting member to affix said housing to said conventional electrical workbox;
ii. A primary power interface within said housing;
iii. A sensing circuit to detect a predetermined condition said sensing circuit providing a signal;
iv. A first interface providing a communication path for said signal, said first interface used to communicate with a system safety device;
b. An alarm input circuit providing an alert signal to said sensing circuit in said electrical wiring device.

11. The alarm input circuit of claim 10 comprising at least one input, said input monitoring a condition comprising one of power failure, intrusion alarm, smoke alarm, gas alarm, water alarm, user input, and darkness.

12. The electrical wiring device of claim 10 comprising a cover plate for said electrical wiring device said cover plate having suitable structure to accommodate one or more modules, said modules selected from the group of safety lighting source, audio alarm source, light transmission means, user interface control, ambient light sensor, alternate power source, second electrical interface, clear or translucent area.

13. The system safety device of claim 10 selected from the group comprised of safety lighting source and audible alarm source.

14. The system safety device of claim 10 comprising a second interface in communication with said first interface.

15. A cover plate for an electric wiring device comprising:
a. An interface for communicating with a sensing circuit in combination with said electric wiring device, said sensing circuit communicating a signal representing a predetermined safety condition;
b. A mounting mechanism to affix said cover plate to said electrical wiring device causing said interface to be in communication with said electrical wiring device.

16. The cover for an electric wiring device of claim 15 comprising a light transmission means to convey light outwardly from said cover plate after installation over said electric wiring device.

17. The cover plate for an electric wiring device of claim 15 comprising a safety light source, said safety light source controlled by said signal.

18. The cover plate for an electric wiring device of claim 15 comprising an audible alarm source, said audible alarm source controlled by said signal.

19. The cover plate for an electric wiring device of claim 15 comprising a circuit board, said circuit board providing electrical signal paths between said interface and one or more modular circuit elements.

20. The cover plate for an electrical wiring device of claim 15 comprising an interface, said interface communicating with said sensing circuit combined with said electrical wiring device, said interface is one of the following: wireless, wired, optical and mating contacts.
